(19) United States
(12) Patent Application Publication
(10) Pub. No.: US 2009/0022151 A1
(43) Pub. Date: Jan. 22, 2009

(54) PACKET STRUCTURE AND PACKET TRANSMISSION METHOD OF NETWORK CONTROL PROTOCOL

(75) Inventors: Woong Jeon, Seoul (KR); Jong Hoon Chung, Gyeonggi-do (KR); Sang Kyun Lee, Seoul (KR); Koon Seok Lee, Kyungsang-namdo (KR)

Correspondence Address: MCKENNA LONG & ALDRIDGE LLP, 1900 K STREET, NW, WASHINGTON, DC, 20006, US

(73) Assignee: LG ELECTRONIC INC., Seoul (KR)

(21) Appl. No.: 11/885,017

(22) PCT Filed: Feb. 24, 2006
(86) PCT No.: PCT/KR06/00653

§ 371 Date: Sep. 26, 2008

(30) Foreign Application Priority Data
Feb. 24, 2005 (KR) 1-=2005-0015575

(51) Int. Cl. H04L 12/28

(52) U.S. Cl. 370/389

(57) ABSTRACT

A packet structure and a packet transmission method of a network control protocol. A user in the inside or outside of the house can effectively control various home appliances such as refrigerator or laundry machine or monitor operation state of the devices, over the living network such as RS-485 network, low-power RF network, and power line network so that the user can enjoy the remote control and the convenient monitoring. In addition, the packet structure for the inter-layer interface of the network control protocol can be managed. The packet structure at the application layer is generated by assigning one of an application layer protocol data unit header, a request message, a response message, and an event message, together with an application layer protocol data unit header The generated packet at the application layer is transmitted to thus interface layers of the network control protocol. Therefore, the packet structure at the application layer can be more efficiently managed and transmitted.

### 1. TECHNICAL FIELD

The present invention relates to a packet structure and a packet transmission method of a network control protocol so that a user, for example, in or out of the house, can effectively control household appliances such as refrigerator or laundry machine connected to a network.

### 2. BACKGROUND ART

In general, ‘home network’ means a network in which various digital appliances are connected to one another for the user to enjoy economical home services in a convenient and safe way anytime at home or out-of-home, and due to the development of digital signal processing technology, various types of appliances such as refrigerator or laundry machine are being gradually digitalized.

On the other hand, in recent years, home network has been more advanced, since operating system and multi-media technology for appliances has been applied to digital appliances, as well as new types of information appliances have appeared.

Moreover, in a general meaning, a network which is established for providing file exchanges or internet services between personal computers and peripheral devices, a network between appliances for handling audio or video information, and a network established for home automation of various appliances such as refrigerator or laundry machine, appliance control such as remote meter reading, and the like are collectively called a ‘living network’.

Furthermore, in the network services in which small-scale data transmission for the remote control, or operating state monitoring of the appliances included in the aforementioned network, for example, various appliances such as refrigerator or laundry machine, is the main object of their communication, each of appliances connected to one another should be directly controlled by a network manager, which is included in the network, with the use of the minimum required communication resources. However, its effective solution has not been provided yet, and thus it is a matter of urgency to provide its solution.

### 3. DISCLOSURE OF THE INVENTION

Accordingly, the present invention is devised in consideration of the aforementioned situation, and it is an object of the invention to provide a packet structure and a packet transmission method of a network control protocol so that a user, for example, in or out of house, can effectively control various appliances such as refrigerator or laundry machine connected to a network by using the required communication resources at minimum, and manage and transmit the packet structure at the application layer far more efficiently for the sake of the interface between layers of the network control protocol.

transmission method of a network control protocol includes generating a packet at an application layer of the network control protocol, the packet assigned a field to which one or more of a request message, a response message, and an event message is assigned, and an application layer protocol data unit header; and interfacing layers in the network control protocol by transmitting the generated packet at the application layer.

In accordance with the aspect of the present invention, a packet structure interfaces layers in a network control protocol including an application layer. The packet structure at the application layer is assigned a field including one or more of a request message, a response message, and an event message, and an application layer protocol data unit header.

In accordance with the aspect of the present invention, a network device includes a network control protocol including one or more of a physical layer, a data link layer, a network layer, and an application layer, wherein a packet structure of the application layer is assigned a field including one or more of a request message, a response message, and an event message, and an application layer protocol data unit header.

### 4. BRIEF DESCRIPTION OF THE DRAWINGS

The above and other objects, features and advantages of the present invention will become apparent from the following description of preferred embodiments given in conjunction with the accompanying drawings, in which:

FIG. 1 illustrates a construction of a network system according to an embodiment of the present invention;

FIGS. 2 and 3 illustrate a communication configuration based on master-slave which is applied to the present invention;

FIG. 4 illustrates a layer structure of a living network control protocol (LnCP) applied to the present invention;

FIGS. 5 through 7 illustrate examples of a communication cycle service applied to the present invention;

FIG. 8 illustrates a layer structure of the LnCP according to an embodiment of the present invention;

FIG. 9 illustrates primitives for interfacing between the network management sublayer and the parameter management layer according to an embodiment of the present invention;

FIG. 10 illustrates a layer interface structure according to an embodiment of the present invention;

FIG. 11 illustrates a universal asynchronous receiver and transmitter (URAT) frame structure according to an embodiment of the present invention;

FIG. 12 illustrates primitives for interfacing between the physical layer and the data link layer according to an embodiment of the present invention;

FIG. 13 illustrates primitives for interfacing between the data link layer and the network layer according to an embodiment of the present invention;

FIG. 14 illustrates a data link layer frame structure according to an embodiment of the present invention;

FIG. 15 illustrates primitives of a master for interfacing between the network layer and the application layer according to an embodiment of the present invention;

FIG. 16 illustrates primitives of a slave for interfacing between the network layer and the application layer according to an embodiment of the present invention;

FIGS. 17 and 18 illustrate primitives of the master for interfacing between the application layer and the application software according to an embodiment of the present invention;

FIG. 19 illustrates primitives of the slave for interfacing between the application layer and the application software according to an embodiment of the present invention;

FIG. 20 illustrates a packet structure management method at the application layer according to an embodiment of the present invention;

FIG. 21 illustrates a structure of request messages according to an embodiment of the present invention;

FIG. 22 illustrates a structure of response messages according to an embodiment of the present invention;

FIG. 23 illustrates a structure of an event message according to an embodiment of the present invention;

FIG. 24 illustrates classification of command code areas according to an embodiment of the present invention; and

FIG. 25 illustrates message field extension according to an embodiment of the present invention.

### 5. BEST MODE FOR CARRYING OUT THE INVENTION

Reference will now be made in detail to the embodiment of the present general inventive concept, examples of which are illustrated in the accompanying drawings, wherein like reference numerals refer to the like elements throughout. The embodiment is described below in order to explain the present general inventive concept by referring to the drawings.

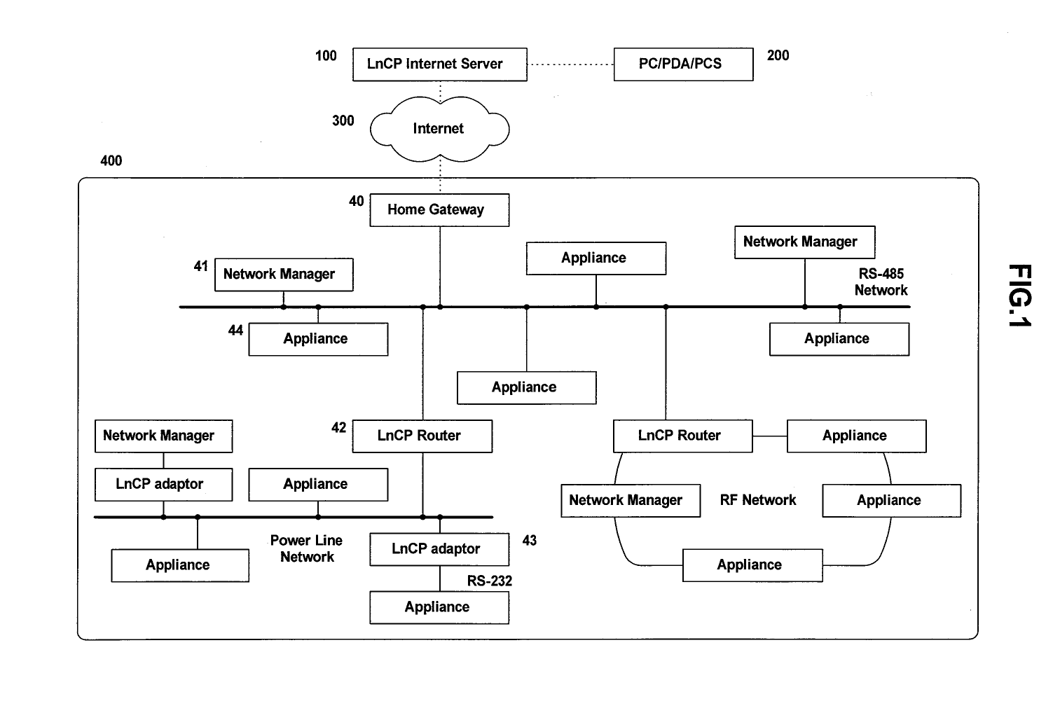

FIG. 1 depicts a construction of a network system according to an embodiment of the present invention. By way of example, a living network control protocol (LnCP), which is a network control protocol newly defined herein, Internet server 100 and a living network control system 400 that adopt the LnCP newly defined in the present invention, are connected to each other via Internet 300 as shown in FIG. 1. The LnCP Internet server 100 serves to interface with various communication terminals 200 such as a personal computer (PC), a personal digital assistant (PDA), a personal communication service (PCS) and the like.

The living network control system 400 comprises a home gateway 40, a network manager 41, an LnCP router 42, an LnCP adaptor 43, and appliances 44. The components of the living network control system 400 use a transmission medium having non-standard data link layer such as RS-485 network and low-power RF network, or a transmission medium having standard data link layer such as power line, IEEE 802.411, ZigBee (IEEE 802.15.4), as shown in FIG. 1.

The living network control system 400 can be called ‘LnCP network’. The LnCP network, as shown in FIG. 1, is established by independent networks that connect home appliances belonging to the living network category through a wired or wireless transmission medium in a separate home.

The LnCP network is connected with a master device and a slave device. The master device is responsible to control or monitor operations or operation states of other home appliances. The slave device has a function to reply to a request from the master device and a function to inform of information relating to its state change.

The network manager 41 is responsible for the environment setup and the management of the appliance 44 connected to the LnCP network as shown in FIG. 1. The appliances 44 can be connected to the network directly or via the LnCP adaptor 43. A RF-485 network, a RF network, and a power line network within the LnCP network are connected via the LnCP router 42.

The LnCP network provides a function to allow a user at the outside to check or control the state of the appliance in the home over a foreign Internet 300 connected to the LnCP network. To this end, the home gateway 40 functions to connect the LnCP network and the foreign network. After accessing the LnCP Internet server 100 and going through the authentication, the user can check the state of the home appliance connected to the LnCP network or control the home appliance.

Additionally, the user can download contents provided from the LnCP Internet server 100, from the appliance connected to the LnCP network by accessing the LnCP Internet server 100 via the home gateway 40. In this respect, the main features of the LnCP network are described below in detail.

The digital information electronic appliances are equipped with micro-controllers providing diverse capabilities so as to perform their unique functions. According to an embodiment of the present invention, the LnCP network further efficiently simplifies the functions so that the micro-controller can execute its diverse capabilities. Hence, the resource of the micro-controller equipped to the appliance can be used at minimum. Particularly, a micro-controller having low capability can process the LnCP communication function while executing the unique function of the appliances, and a micro-controller having high capability can support the multi-tasking function.

The main features of the LnCP network can be classified into master-slave based communication configuration, event-driven communication support, support for a plurality of network managers, four-layered structure, communication cycle service, flexible address management, variable-length packet communication, and standard message set provision.

The master-slave based communication configuration is used as a link communication configuration among the home appliances over the LnCP network. At least more than one master device is required, and the master device needs to have information and control codes relating to slave devices to be controlled. The master device controls other slave devices by following a pre-input program or a user s input. Hereafter, the master device is also referred to as a master, and the slave master is also referred to as a slave.

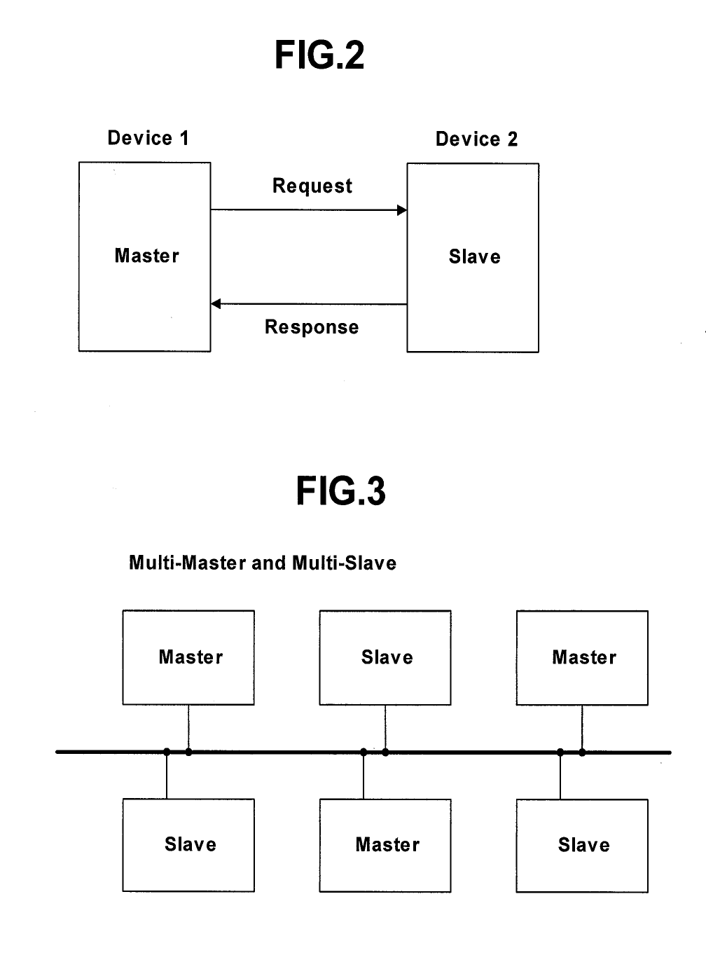

For instance, a message flow between the master and a slave is carried out in a manner that the master sends a request message to the slave and then the slave replies with a response message to the master as shown in FIG. 2. In the LnCP network, a multi-master and multi-slave based communication configuration may be established as shown in FIG. 3.

The LnCP network supports the event-driven communication service. For instance, the user can set a necessary event at the home appliance. When the event set by the user occurs during a certain operation afterwards, the home appliance informs other home appliances of the event occurrence or the event contents, or controls the operation state of other home appliances in accordance with the event.

At least more than one network manager is included in the LnCP network to take charge of the environment setup and the management of the home appliances. If necessary, the LnCP network can support a plurality of network managers. In this case, the management information of the home appliances should be synchronized to avoid errors at the plurality of the network managers in advance.

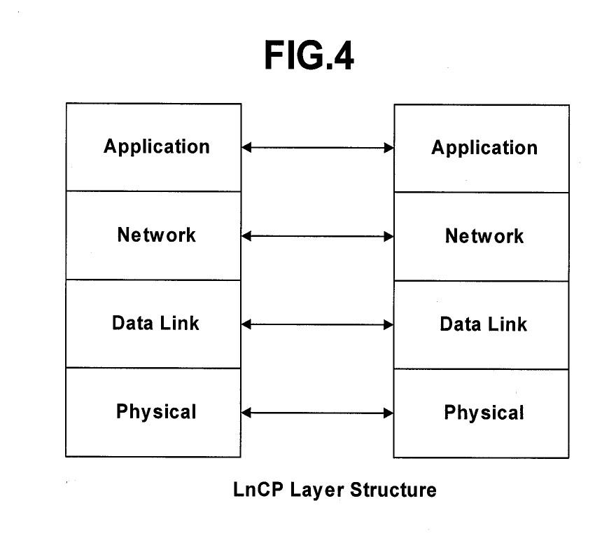

Referring to FIG. 4, the LnCP network has four layers: the physical layer, the data link layer, the network layer, and the application layer. The LnCP network provides services by unit of the communication cycle. In doing so, only one communication cycle is present at a given time point on the slave.

In more detail, although a slave cannot be controlled by any other master during the communication cycle, the master can process a plurality of communication cycles for a plurality of slave at a given time. Such a communication cycle includes four types: {1-Requst, 1-Response}, {1-Request, Multi-Response}, {1-Notification}, and {Repeated-Notification}.

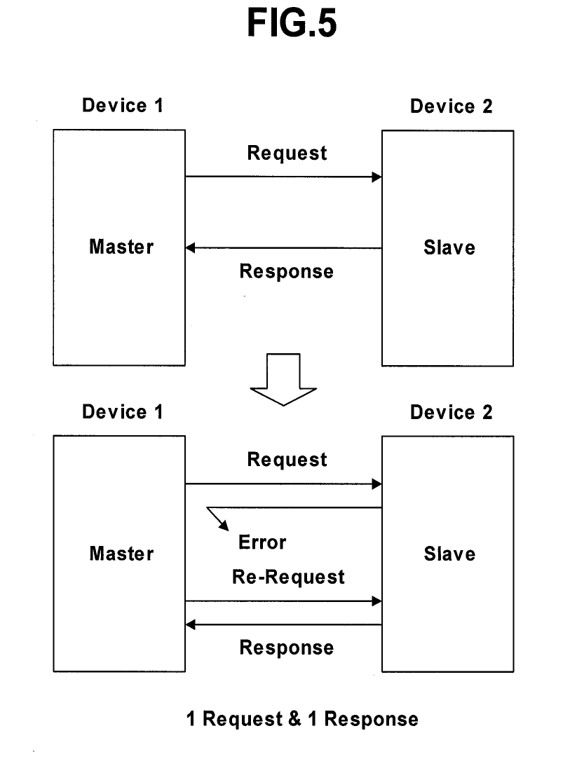

By way of example, during the communication cycle {1-Requst, 1-Response}, a master sends a request packet to a slave, and the slave replies with a response packet. If the received packet is erroneous, the master sends a re-request packet and the slave replies a response packet again a shown in FIG. 5.

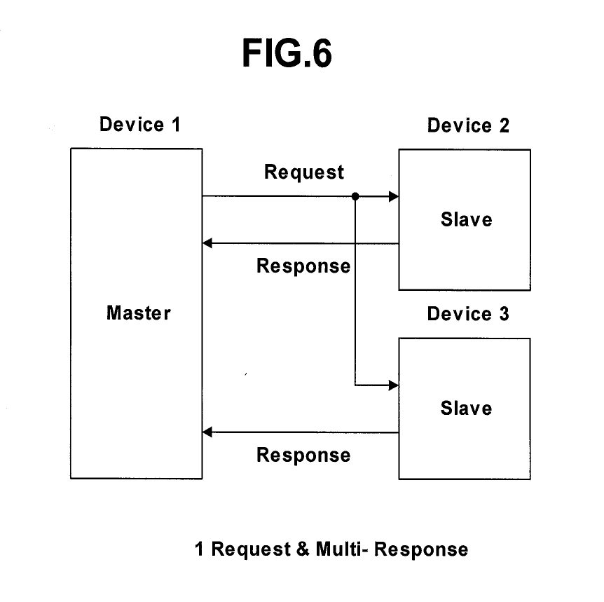

Referring to FIG. 6, during the communication cycle {1-Request, Multi-Response}, a master sends a request packet containing a group address to a plurality of slaves, and each slave sends a response packet in reply to the request packet. The master terminates the cycle after a permissible maximum reception time. When the response packet received after the permissible maximum reception time is erroneous, the master ignores the packet error.

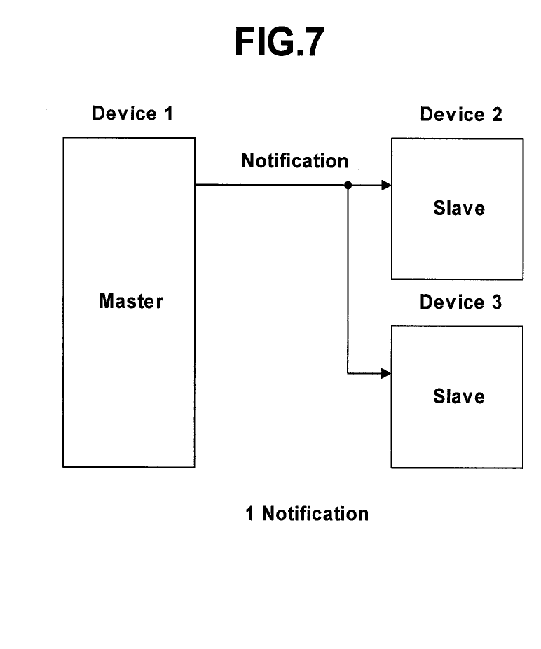

Referring now to FIG. 7, during the communication cycle {1-Notification}, a master terminates the communication immediately after sending a notification packet to one or plural slaves. As for the communication cycle {Repeated-Notification}, the communication is terminated after repeatedly sending the same packet so as to guarantee the transmission reliability in the communication cycle {1-Notification}.

The LnCP network supports the flexible address management. For instance, the home appliances having the LnCP function are assigned addresses according to their types when the home appliances are forwarded from the factory, to thus automatically establish networks. As the home appliances of the same type are initialized to the same address, the network manager is provided with an algorithm to assign unique addresses to the home appliances when they are connected.

Since the LnCP network allocates a unique group address to the home appliances of the same type, the group communication is enabled using merely one message. Also, if necessary, the user can classify a variety of home appliances into clusters and assign group addresses to the clusters, respectively.

The LnCP network supports the variable-length packet communication. For example, in case of downloading contents such as application program relating to the manipulation of the home appliance or uploading data stored in the home appliance, the packet length is adjustable using exchanged buffer size information of the home appliance.

The LnCP network supports the standard message set. For example, a standard message set suitable for various home appliances is defined at the application layer so that the master can control other appliances. The message set is divided into a common function area message set for supporting basic LnCP communication, a product application area message set for supporting the unique function of the home appliance, and a developer area message set for providing unique functions of the manufacturer.

The message set can be extended if necessary, and an argument can be added to a predefined message. In the following, among the main features of the LnCP network, the layer structure is described in further detail.

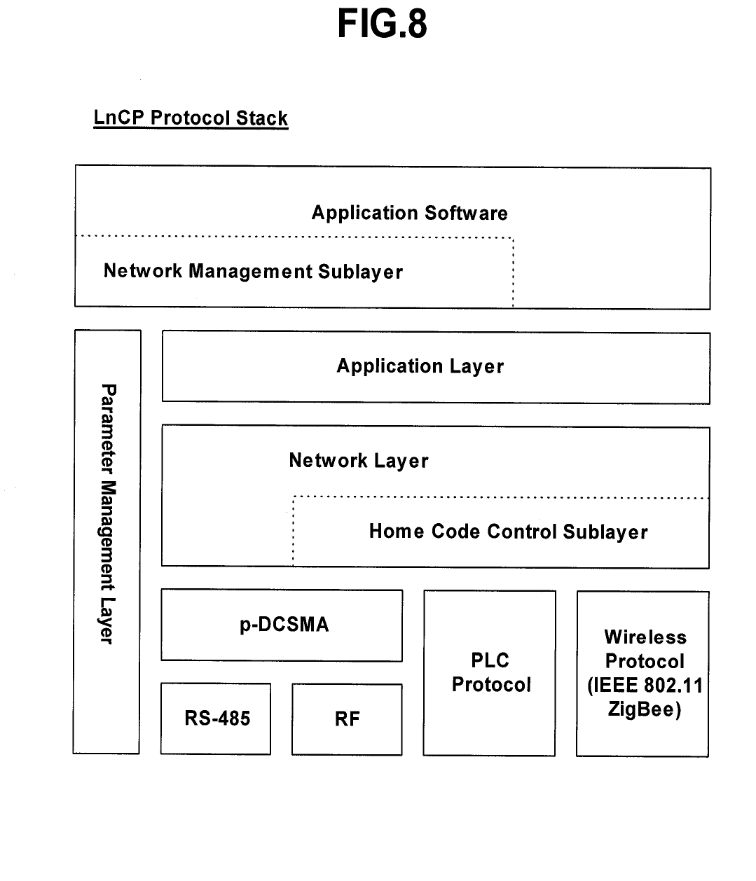

FIG. 8 depicts the layer structure of the LnCP protocol according to an embodiment of the present invention. As discussed above, the LnCP network has the four layers of the physical layer, the data link layer, the network layer, and the application layer for the sake of the operation control and the monitoring of the home appliances such as refrigerator or washer.

The physical layer provides a physical interface between devices, and a function for transmitting and receiving a physical signal such as bits to transmit. The physical layer may employ a transmission medium having the non-standard data link layer such as RS-485 or low-power RF, and a wired or wireless standard transmission medium such as power line communication, Ethernet, IEEE 802.11, and ZigBee. To implement the physical layer of the device in the LnCP network, a separate physical layer may adapt an LnCP adaptor.

The data link layer provides a media access control (MAC) function to use a shared transmission medium. If the data link layer uses a non-standard transmission medium, the LnCP network should conform to a probabilistic-delayed carrier sense multiple access (p-DCSMA) as the MAC protocol.

In contrast, if the data link layer uses a standard transmission medium, the LnCP network can utilize the MAC function specified by a corresponding protocol.

Still referring to FIG. 8, a home code control sublayer provides functions for setting, managing, and processing a home code which is used to logically discriminate the respective networks when the LnCP network is established using the non-standard transmission medium such as power line network, IEEE 802.11, ZigBee, and low-power RF. It is advantageous that the home code control sublayer is not implemented when the respective networks are physically separated by means of the standard transmission medium such as RS-485.

The network layer functions to manage addresses and control the transmission and the reception of the home appliances for the reliable network connections among devices. The application layer serves to control the transmission and the reception and to control the flow for the download and the upload services so as to perform services of application software.

The application layer defines the message set to manage the network or control and monitor the home appliances. The application software executes unique functions of the home appliance and exchanges data with the application layer via an interface designated at the application layer.

As shown in FIG. 8, the network management sublayer functions to manage parameters to set node parameters and to manage the network for the network establishment and the network management. A parameter management layer can set or read parameters used at the respective layers according to a request from the network management sublayer.

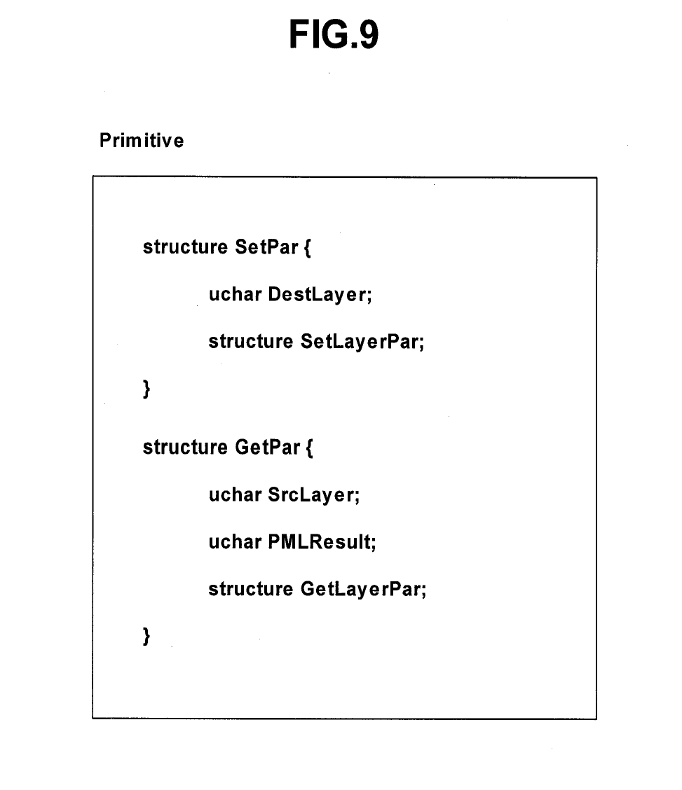

Referring now to FIG. 9, primitives for interfacing with the network management sublayer include a primitive ‘structure SetPar’ for transferring a parameter value from the network management sublayer to the parameter management layer, and a primitive ‘structure GetPar’ to transfer a parameter value from the parameter management layer to the network management sublayer.

The primitive ‘structure SetPar’ for transferring the parameter value to the parameter management layer, includes ‘uchar DestLayer’ indicating a layer the parameter is destined for and ‘structure SetLayerPar’ which is a parameter for each layer and varies according to the value of ‘DestLayer’. The ‘DestLayer’ is 1 when the parameter value is destined for the application layer, 2 when destined for the network layer, 3 when destined for the data link layer, and 4 when destined for the physical layer.

The ‘SetLayerPar’ is ‘SetALPar’ as for the application layer, ‘SetNLPar’ as for the network layer, ‘SetDLLPar’ as for the data link layer, and ‘SetPHYPar’ as for the physical layer.

The primitive structure ‘GetPar’ for transferring the parameter value to the network management sublayer includes ‘uchar SrcLayer’ indicating a layer to which the parameter value is transferred, ‘uchar PMLResult’ indicating whether the parameter value is successfully acquired from each layer, and ‘structure GetLayerPar’ which is a parameter for each layer and varies according to ‘SrcLayer’. According to the layer to which the parameter value is transferred, the SrcLayer is 1 as for the application layer, 2 as for the network layer, 3 as for the data link layer, and 4 as for the physical layer.

The ‘PMLResult’ is PAR_OK(1) when the parameter value is successfully acquired from each layer, and PAR_FAILD(0) when the parameter value is not successfully acquired from each layer. The ‘GetLayerPar’ is ‘RptALPar’ as for the application layer, ‘RptNLPar’ as for the network layer, ‘RptDLLPar’ as for the data link layer, and ‘RptPHYPar’ as for the physical layer.

A parameter used at the parameter management layer is const unit ‘ParTimeOut’. The ‘const unit ParTimeOut’ indicates a standby time ms for receiving ‘RptALPar’, ‘RptNLPar’, ‘RptDLLPar’ or ‘RptPHYPar’ after transferring ‘GetALPar’, ‘GetNLPar’, ‘GetDLLPar’ or ‘GetPHYPar’ to each layer.

The parameter management layer, upon receiving the primitive ‘SetPar’ from the network management sublayer, transfers the primitive ‘SetALPar’, ‘SetNLPar’, ‘SetDLLPar’ or ‘SetPHYPar’ to the layer specified in the primitive, and ignores every variable having bit 1, e.g., 0×FF and 0×FFFF, in the primitives received from the respective layers.

Upon receiving the primitive ‘GetPar’ from the network management sublayer, the parameter management layer transfers the primitive ‘GetALPar’, ‘GetLNPar’, ‘GetDLLPar’, or ‘GetPHYPar’ to the layer specified in the primitive. Upon receiving the primitive ‘RptALPar’, ‘RptNLPar’, ‘RptDLLPar’ or ‘RptPHYPar’ from the layer, the parameter management layer transfers the primitive ‘GetPar’ having the value ‘PARResult’ set to PAR_OK to the network management sublayer. In doing so, if the primitive is not received from the layer within the time ‘ParTimeOut’, the primitive is transferred to the network management sublayer by setting the value ‘PARResult’ to ‘PAR FAILD’.

The network management sublayer provides the parameter management function for setting a node parameter at each device, and the function for establishing the network, setting the environment, and managing the operation of the network. When a request is received from the application software or the master, the network management sublayer sets or reads out the parameter value of the corresponding layer through the parameter management layer as follows.

For instance, the network management sublayer sets or reads out the parameter value of AddressResult, NP_AliveInt, SvcTimeOut as for the application layer, NP_Logical Address, NP_ClusterCode, NP_HomeCode, SendRetries as for the network layer, MinPktInterval as for the data link layer, and NP_bps as for the physical layer.

Particularly, when receiving a primitive ‘UserReqRcv’ including the application service belonging to the ‘device node parameter set service’ or the ‘device node parameter acquisition service’ from the application layer, the network management sublayer of the slave sets or reads out the parameter value of the corresponding layer through the parameter management layer, and then transfers the result to the application layer using the primitive ‘UserResSend’. The application service for the parameter management for the layers is as below.

For instance, the application layer has SetOption service, SetAliveTime service, SetClock service, GetBufferSize service, the network layer has SetTempAddress service, SetAddress service, GetAddress service, the data link layer has no service, and the physical layer has SetSpeed service.

The network management sublayer provides the network management functions including the LnCP network establishment, the environment setup, and the network operation management. The general network management functions work above the application layer of the master, and some of network information synchronization functions work above the application layer of the slave during a plurality of network management periods.

The interface with the application layer includes the interface with the application layer of the slave and the interface with the application layer of the master. The interface with the application layer of the slave utilizes primitives ‘UserReqRcv’ and ‘UserResSend’, and the interface with the application layer of the master utilizes primitives ‘UserReq’, ‘UserDLReq’, ‘UserULReq’, ‘UserRes’ ‘UserEventRcv’, and ‘ALCompleted’.

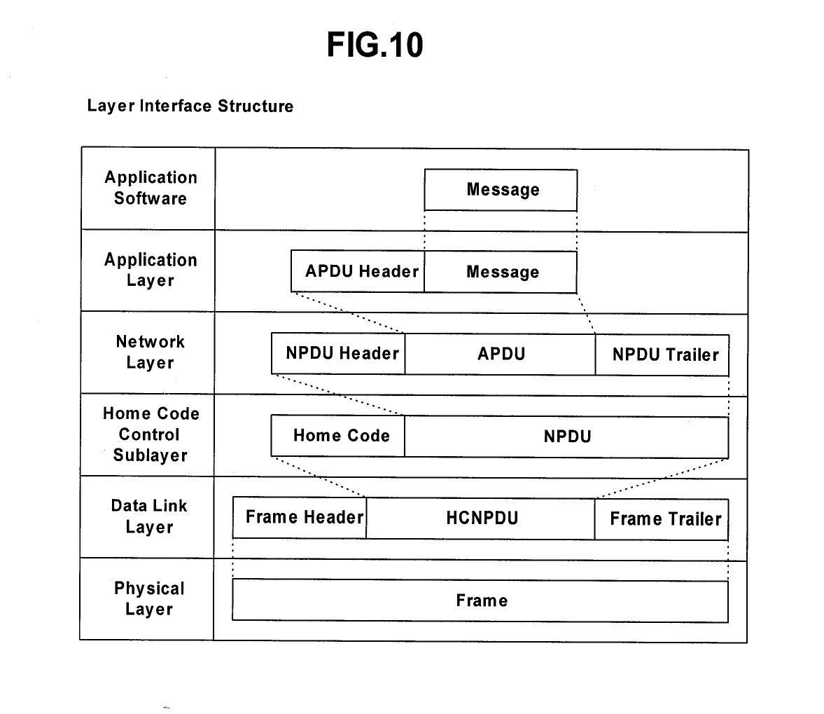

According to an embodiment of the present invention, the inter-layer interfacing method in the living network control system merges header and trailer information required at each layer into a protocol data unit (PDU) received from an upper layer, and transfers it to a lower layer as shown in FIG. 10.

By way of example, an application layer PDU (APDU) is delivered between the application layer and the network layer, and consists of an APDU header and a message. A network layer PDU (NPDU) is delivered between the network layer and the data link layer or the home code control sublayer, and consists of a NPDU header, a NPDU trailer, and the APDU. The NPDU header may be addresses of the APDU and the NPDU, an address of a destination home appliance, and a packet type according to the significance of the transferred message.

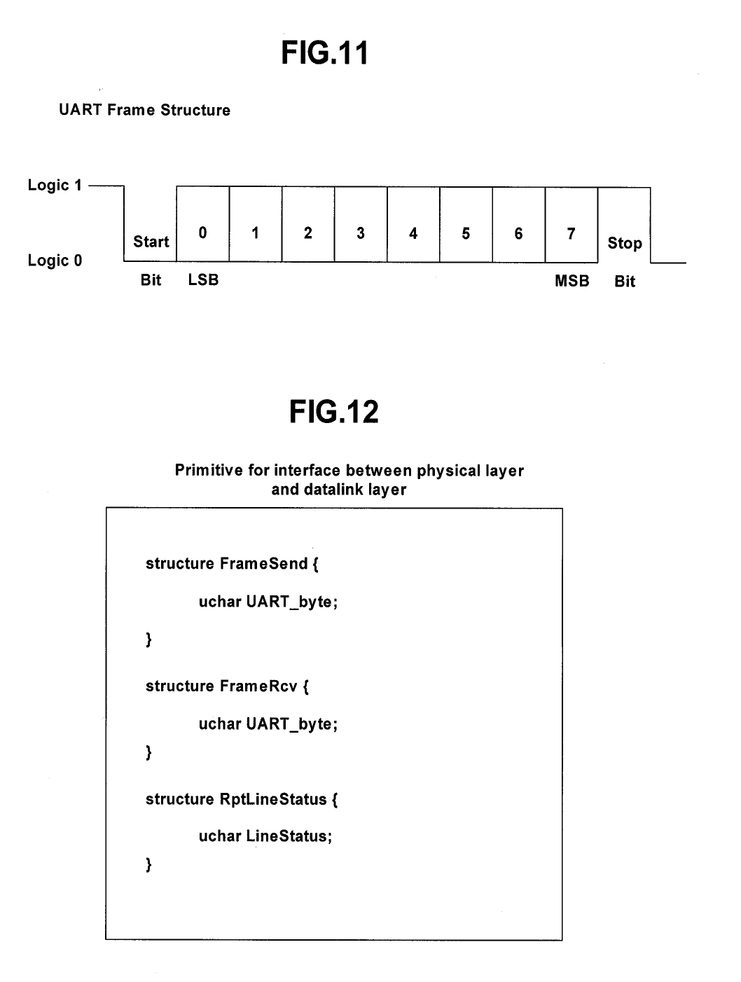

A home code control sublayer PDU (HCNPDU) is delivered between the network layer and the data link layer, and consists of the NPDU and a home code. The physical layer of the LnCP network takes advantage of a universal asynchronous receiver and transmitter (UART) frame structure, as shown in FIG. 11, for the interface between the device and the LnCP adaptor or the LnCP router.

A packet received from the upper layer is converted to a UART frame unit of 10-bit size and transferred through the transmission medium. The UART frame of the LnCP network consists of a 1-bit start bit, 8-bit data, and a 1-bit stop bit. The UART frame does not use a parity bit, and the bits from the start bit to the stop bit are transferred in that order.

In case that the UART is adopted in the LnCP network, additional frame headers and frame trailers are not used. At this time, the data speed may be 9600 bps, 4800 bps, or 19200 bps depending on the device capability.

Referring to FIG. 12, primitives for the interface between the physical layer and the data link layer are a primitive ‘FrameSend’ for transferring 1-byte data from the data link layer to the physical layer, a primitive ‘FrameRcv’ for transferring 1-byte data from the physical layer to the data link layer, and a primitive ‘RptLineStatus’ relating to the link status linked to the data link layer. When the UART frame is present in the line, LINE_BSY is transferred, or otherwise, LINE-IDLE is transferred.

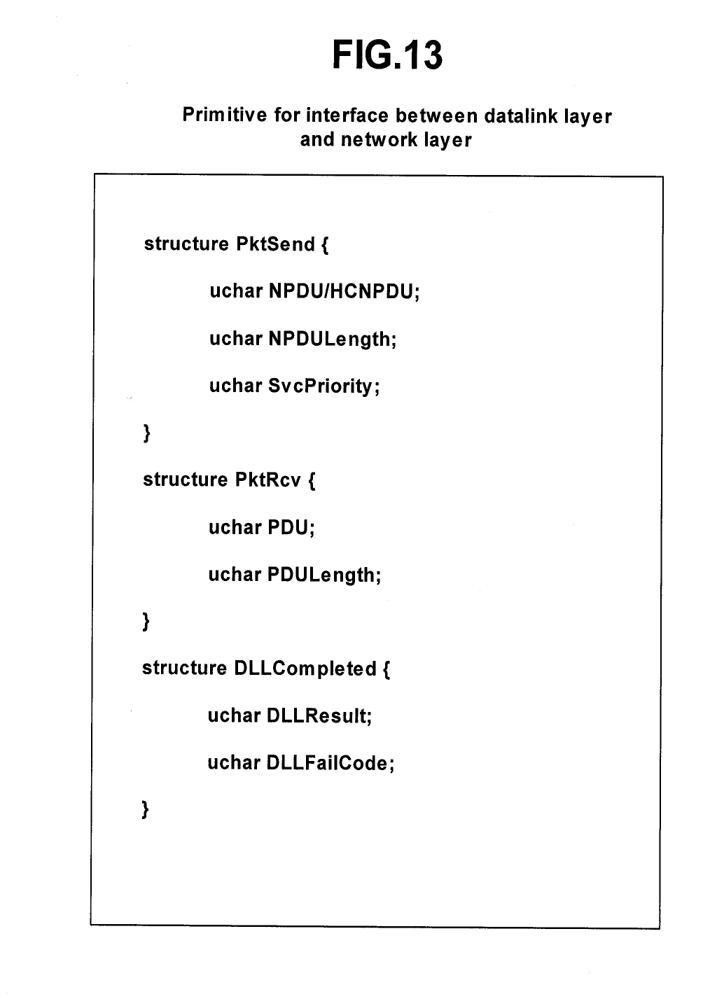

As shown in FIG. 13, primitives for the interface between the data link layer and the network layer are a primitive ‘PktSend’ for transferring packets from the network layer to the data link layer, a primitive ‘PktRcv’ for transferring packets from the data link layer to the network layer, and a primitive ‘DLLComplete’ for informing of the packet transfer result from the data link layer to the network layer.

The primitive ‘PktSend’ contains records of the packet NPDU/HCNPDU of the network layer, the byte data length of the NPDU/HCNPDU, and the transfer priority ‘SvcPriority’. The primitive PktRcv contains records relating to the packet PDU of the network layer and the data length of PDU ‘PDULength’. When the packet transfer is successfully completed as the packet transfer result ‘DLLResult’, ‘SEND_OK(1)’ is recorded in the primitive ‘DLLCompleted’, or otherwise, ‘SEND_FAILED(0)’ is recorded. When the ‘DLLResult’ is ‘SEND_FAILED(0)’, a value classifying the failure cause ‘DLLFailCode’ is recorded.

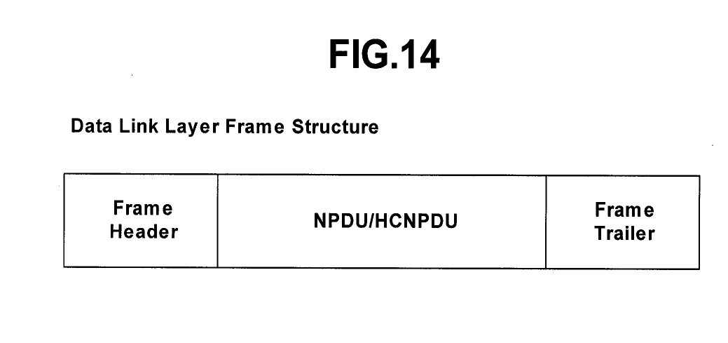

Referring to FIG. 14, the data link frame structure consists of a frame header and a frame trailer in addition to the NPDU/HCNPDU. If the data link layer uses the non-standard transmission medium, a null field is recorded in the frame header and the frame trailer. If the standard transmission medium is used, the corresponding protocol is conformed. The NPDU field is a data unit transferred from the upper network layer.

The HCNPDU is a data unit to which the home code, which is used in case that the physical layer is the non-standard transmission medium, is appended to the front. The data link layer does not discriminate between the NPDU and the HCNPDU during the processing.

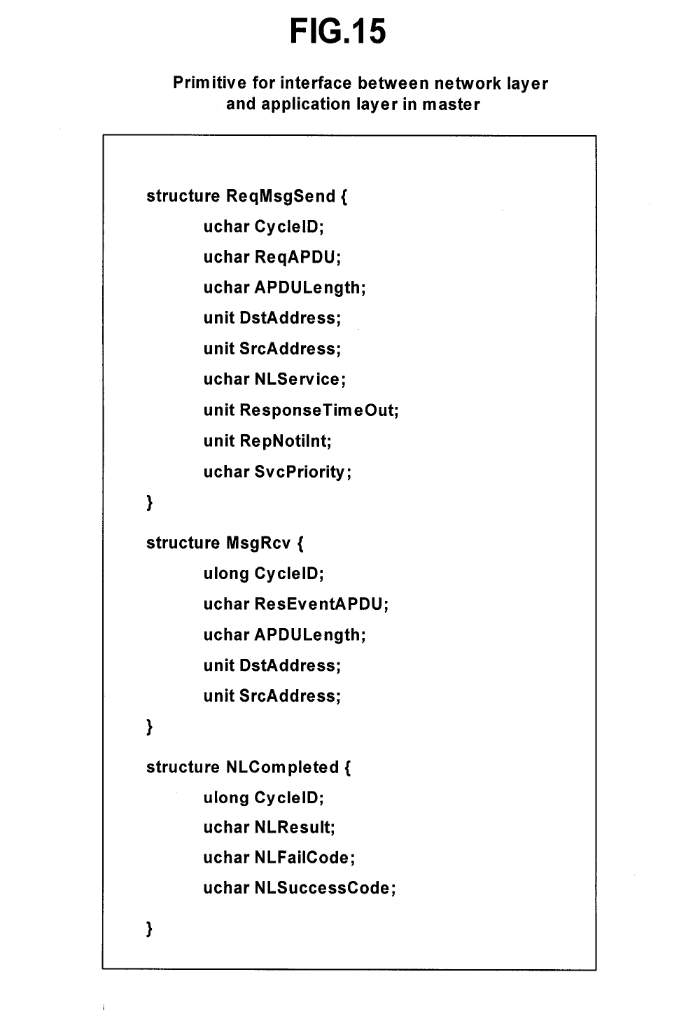

The interface of the network layer differs depending on the master and the slave. Referring to FIG. 15, for the interface between the network layer and the application layer, the master utilizes the primitives ‘ReqMsgSend’, ‘MsgRcv’ and ‘NLCompleted’. The primitive ‘ReqMsgSend’ for transferring a message from the application layer to the network layer at the master, includes records relating to an identification (ID) of the communication cycle ‘CycleID’, an APDU including the request message originated at the application layer of the master ‘ReqAPDU’, a byte data length of the ‘APDU APDULength’, an address of the destination device ‘DstAddress’, an address of the source device ‘SrcAddress’, a communication cycle service type of the master ‘NLService’ (e.g., 0=Acknowledged, 1=Non-acknowledged, 2=Repeated-notification), a time ‘ResponseTimeOut’ for expecting a response packet after transferring the request packet to the master when the ‘NLService’ is ‘Acknowledged’, a time interval ‘RepNotiInt’ between the consecutive notification packets when the ‘NLService’ is ‘Repeated-notification’, and a transmission priority of the request message ‘SvcPriority’.

The primitive ‘MsgRcv’ for delivering packets from the network layer to the application layer of the master, contains records relating to the ID of the communication cycle ‘CycleID’, the APDU to be transferred to the application layer ‘ResEventAPDU’, the byte data length of the APDU ‘APDULength’, the address of the destination device ‘DstAddress’, and the address of the source device ‘SrcAddress’.

The primitive ‘NLCompleted’ for informing the packet processing state from the network layer to the application layer, contains the ID of the communication cycle ‘CycleID’ and the result of the communication cycle ‘NLResult’. In case of the successful communication cycle, ‘CYCLE_OK(1)’ is recorded, or otherwise, ‘CYCLE_FAILED(0)’ is recorded. When the ‘NLService’ is ‘CYCLE_FAILED’, a value classifying the failure cause ‘NLFailCode’ is recorded. When the ‘NLService’ is ‘CYCLE_OK’, the number of the re-transmission times ‘NLSuccessCode’ is recorded.

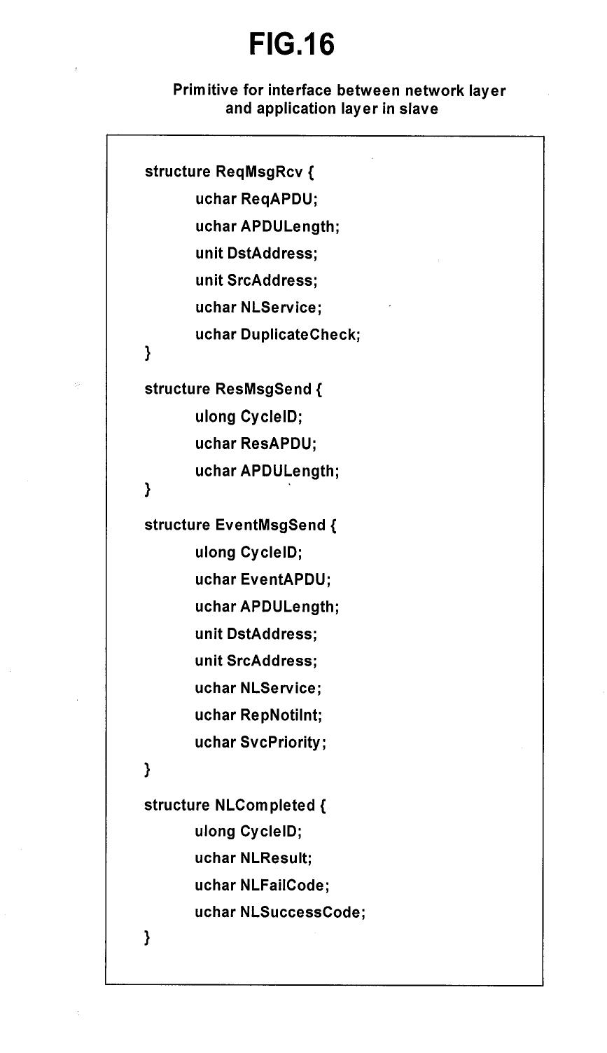

Referring to FIG. 16, the slave utilizes primitives ‘ReqMsgRcv’, ‘ResMsgSend’, ‘EventMsgSend’, and ‘NLCompleted’ for the interface between the network layer and the application layer. The primitive ‘ReqMsgRcv’ for forwarding the request message transferred from the network layer to the application layer contains the APDU to be transferred to the application layer ‘ReqAPDU’, the byte data length of the APDU ‘APDULength’, the destination address ‘DstAddress’, the source address ‘SrcAddress’, and the communication cycle service type of the slave ‘NLService’ (e.g., 0=Acknowledged, 1=Non-acknowledged). In addition, when a result of the duplicate packet detection is normal, ‘NORMAL_PKT(1) is recorded. When a duplicate packet is detected, ‘DUPLICATED_PKT(0)’ is recorded.

The primitive ‘ResMsgSend’ for delivering a response message from the application layer to the network layer of the slave, contains the ID of the communication cycle ‘CycleID’, the APDU including a response message ‘ResAPDU’ originated at the application layer of the slave, and the byte data length of the APDU ‘APDULength’.

The primitive ‘EventMsgSend’ for transferring a message from the application layer to the network layer of the slave, contains the ID of the communication cycle ‘CycleID’, the APDU including an event message ‘EventAPDU’ originated at the application layer of the slave, the byte data length of the APDU ‘APDULength’, the destination address ‘DstAddress’, the source address ‘SrcAddress’, and the transmission service at the network layer ‘NLService’ (e.g., 1=Non-acknowledged, 2=Repeated-notification). When the ‘NLService’ is ‘Repeated-notification’, the time interval between consecutive notification packets ‘RepNotiInt’ and the transmission priority of the event message ‘SvcPriority’ are recorded.

The primitive ‘NLCompleted’ for informing of the packet process state from the network layer to the application layer, contains the ID of the communication cycle ‘CycleID’ and the result of the communication cycle ‘NLResult’. In case of the successful communication cycle, ‘CYCLE_OK(1)’ is recorded, or otherwise, ‘CYCLE_FAILED(0)’ is recorded. When the ‘NLService’ is ‘CYCLE_FAILED’, a value classifying the failure cause ‘NLFailCode’ is recorded. When the ‘NLService’ is ‘CYCLE_OK’, the number of the re-transmission times ‘NLSuccessCode’ is recorded.

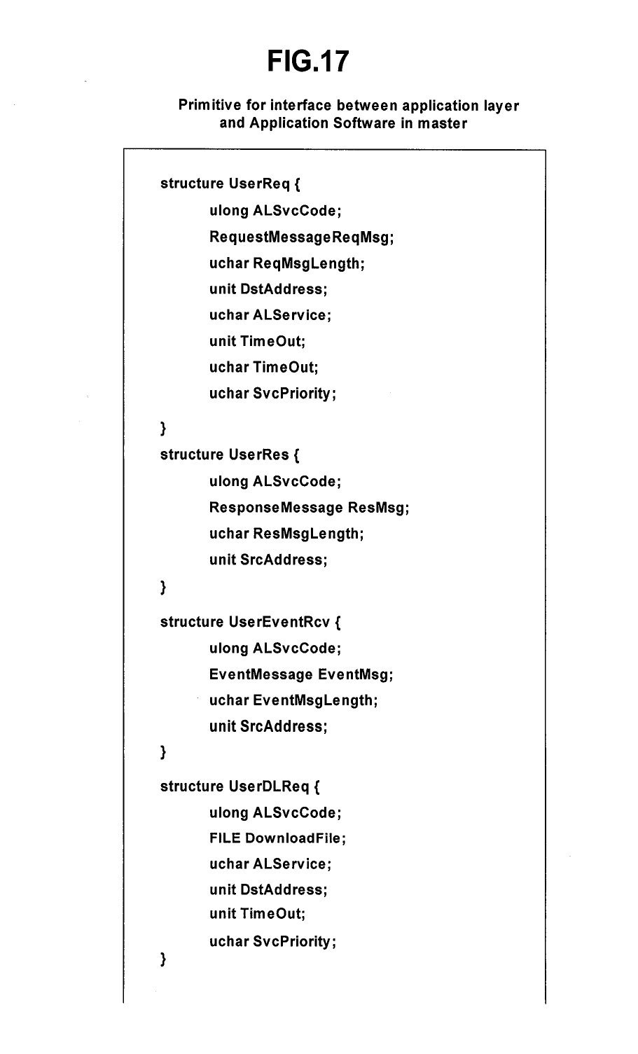

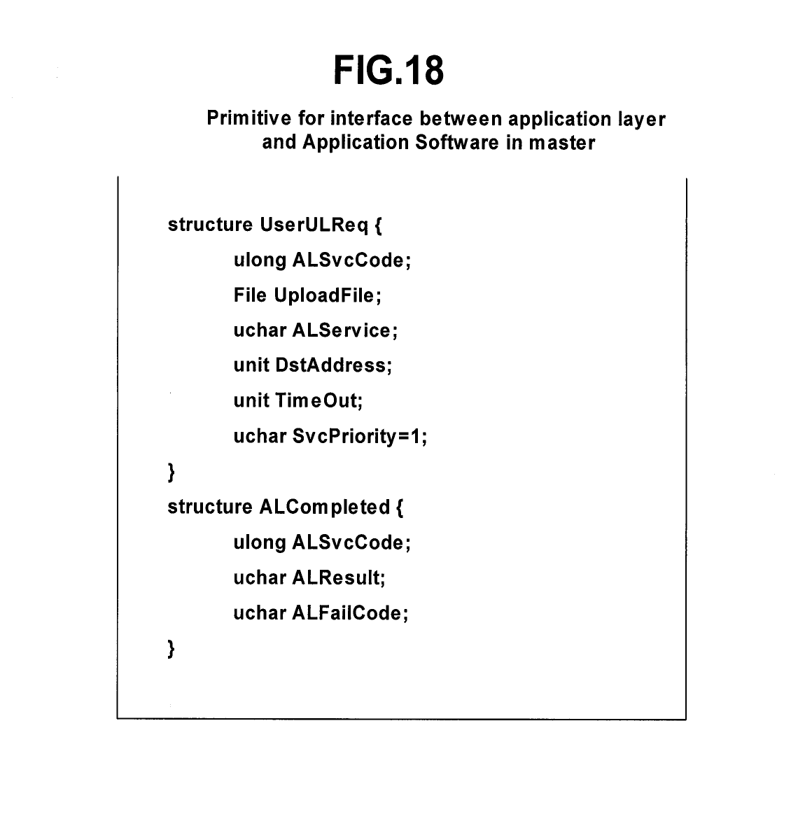

Referring now to FIGS. 17 and 18, the master uses primitives ‘UserReq’, ‘UserDLReq’, ‘UserULReq’, ‘UserRes’ ‘UserEvent’, and ‘ALCompleted’ for the interface with the application software. The service request primitive ‘UserReq’ received from the application software of the master contains records relating to a combination ‘ALsvcCode’ of a product code and a command code as a service code of the application layer, a request message ‘ReqMsg’ consisting of the command code and incoming arguments, a byte data length ‘ReqMsgLength’ of ‘ReqMsg’, a destination address ‘DstAddress’, and a transmitted service type ‘ALService’ (e.g., 0=Request-response-message, 1=Request-message-only, 2=Repeated-message, 3=Event-message-only) . When ‘ALService’ is the request-response-message, a time ms for the master to expect a response packet after transmitting a request packet is recorded. When ‘ALService’ is the repeated-message, a time interval ‘TimeOut’ between consecutive messages and a transmission priority ‘SvcPriority’ are recorded.

The primitive ‘UserRes’ for transferring a result of the service execution with respect to the request message of the master, contains records relating to the combination ‘ALSvcCode’ of the product code and the command code as the service code of the application layer, a response message ‘ResMsg’ consisting of the command code and return arguments, a byte data length ‘ResMsgLength’ of ‘ResMsg’, and a source address ‘SrcAddress’.

The primitive ‘UserEventRcv’ for forwarding an event message received from the slave to the application software of the master, contains records relating to a combination ‘ALSvcCode’ of the product code, the command code, and an event code as the service code of the application layer, the event message ‘EventMsg’ received from the slave, a byte data length ‘EventMsgLenght’ of ‘EventMsg’, and the source address ‘SrcAddress’.

The request primitive ‘UserDLReq’ for the network manager to transmit data to a device connected to the network, contains records relating to the combination ‘ALSvcCode’ of the product code and the command code as the service code of the application layer, a downloading data file name ‘DownloadFile’, a transmitted service type ‘ALService’ fixed to Request-response-message(0), the destination address ‘DstAddress’, a time ‘TimeOut’ for the network manager to expect a response packet after transmitting a request packet, and the transmission priority ‘SvcPriority’ fixed to 1.

The request primitive ‘UserULReq’ for the network manager to receive data from the device connected to the network, contains records relating to the combination ‘ALSvcCode’ of the product code and the command code as the service code of the application layer, a file name ‘UploadFile’ to store uploading data, a transmitted service type ‘ALService’ fixed to Request-response-message(0), the destination address ‘DstAddress’, the time ‘TimeOut’ for the network manager to expect a response packet after transmitting the request packet, and the transmission priority ‘SvcPrioirty’ fixed to 1.

The primitive ‘ALCompleted’ for transferring the service execution result from the application layer of the master to the application software, contains records relating to the combination ‘ALSvcCode’ of the product code and the command code as the service code of the application layer, and the service execution result ‘ALResult’. If the service requested by the application software is successfully completed, SERVICE_OK(1) is recorded, or otherwise, SERVICE FAILED(0) is recorded. When the ‘ALResult’ is SERVICE_FAILD, a value ‘ALFailCode’ which classifies the failure cause is recorded.

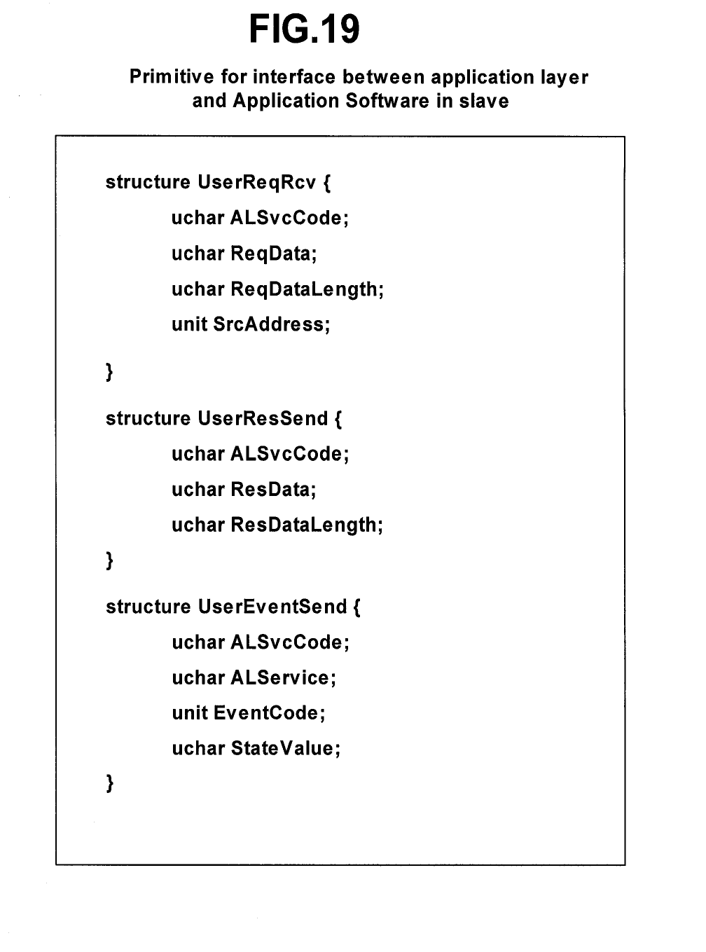

Referring to FIG. 19, the slave utilizes primitives ‘UserResSend’, ‘UserReqRcv’, and ‘UserEventSend’. The primitive ‘UserReqRcv’ for forwarding a request message (including download and upload) received from the master to the application software of the slave, contains records relating to the combination ‘ALSvcCode’ of the product code and the command code as the service code of the application layer, data ‘ReqData’ contained in the request message received from the master, a ‘ReqData’ length ‘ReqDataLength’ and the source address ‘SrcAddress’.

The primitive ‘UserResSend’ for transferring a response message for the request message of the master to the application layer of the slave contains records relating to the combination ‘ALSvcCode’ of the product code and the command code as the service code of the application layer, data ‘ResData’ contained in the response message to transmit to the master, and a ‘ResData’ length ‘ResDataLength’.

The primitive ‘UserEventSend’ for transferring a state variable value of the event message, to transmit to the master, of the slave to the application layer, contains records relating to the combination ‘ALSvcCode’ of the product code, the command code, and an event code as the service code of the application layer, a transmitted service type ‘ALService’ (e.g., 2=Repeated-message, 3=Event-message-only), the event code ‘EventCode’, and the state variable value StateValue of the event message.

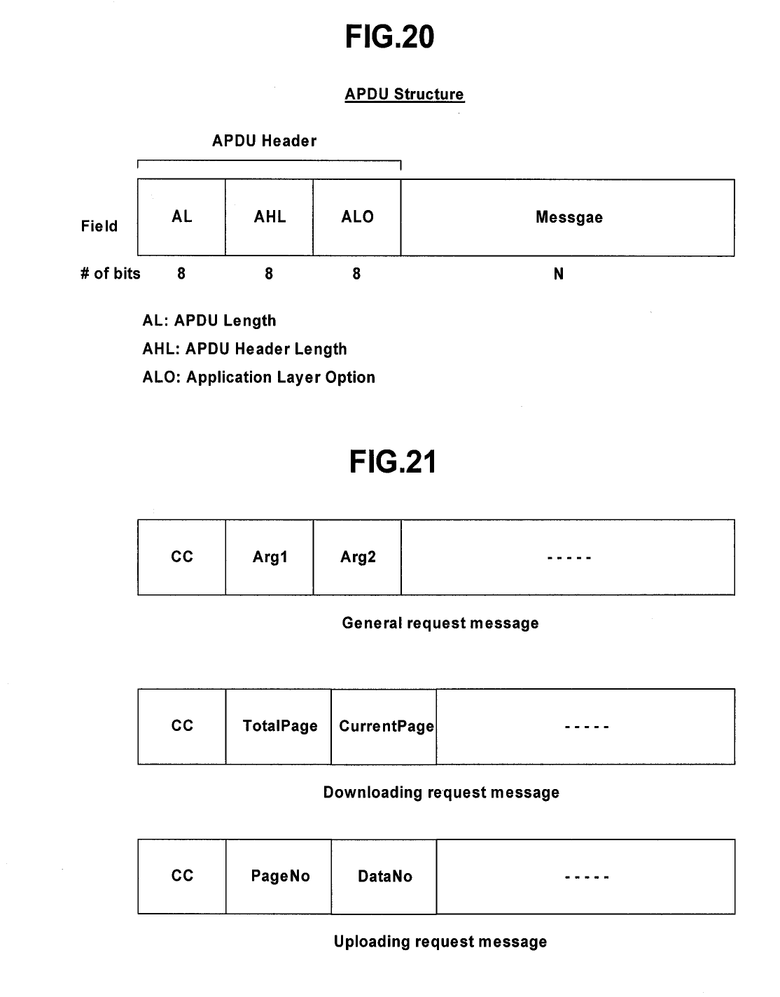

FIG. 20 depicts the packet structure management method at the application layer according to an embodiment of the present invention. By way of example, the packet structure at the application layer consists of an APDU header and a message. The APDU header consists of an APDU length (AL) field, an APDU header length (AHL) field, and an application layer option (ALO) field.

The AL field consists of 8 bytes indicative of the length of the APDU. The AL field is 3 bytes at minimum and 77 bytes at maximum. The length of the used APDU is represented by bytes in the AL field. The AHL field consists of 8 bits indicative of the length of the APDU header. The AHL field can be extended to 3 through 7 bytes. In the LnCP network, the APDU header can be extended up to 7 bytes for the message field encryption, the application protocol change, and the like.

In the APDU header received from a device adopting the LnCP version, for example, the LnCP version 2.0, the APDU header exceeding 3 bytes is ignored and the length of the used APDU header is represented in the AHL field by bytes. The ALO field is provided to extend the message set. As for the LnCP version 2.0, the ALO field has a value of 0. As for a value other than 0, the ALO field is ignored.

The message field processes a control message or event information of the application software. The message field is constructed by the message set separated by the ALO field. Byte or bit data is recorded in the message in order starting from the upper byte or bite in the most significant bit (MSB) first mode.

The type of the messages handled at the application layer includes a request message, a response message, and an event message. The request message is transferred from the application layer to the network layer at the master, or from the network layer to the application layer at the slave so that the slave can execute the command. The application layer of the slave can reply with the response message according to ‘NLService’ received from the network layer.

The request message, as shown in FIG. 21, consists of a command code (CC) and, if required, relevant arguments Arg1, Arg2, . . . for executing the CC. The request message is used to check the control, the status, and the information of the device. Particularly, a request message including input arguments TotalPage and CurrentPage to transmit data partitioned from the request message to the device, is called a downloading request message. A request message including Input arguments ‘PageNo’ and ‘DataNo’ to acquire partitioned data from the device is called a uploading request message.

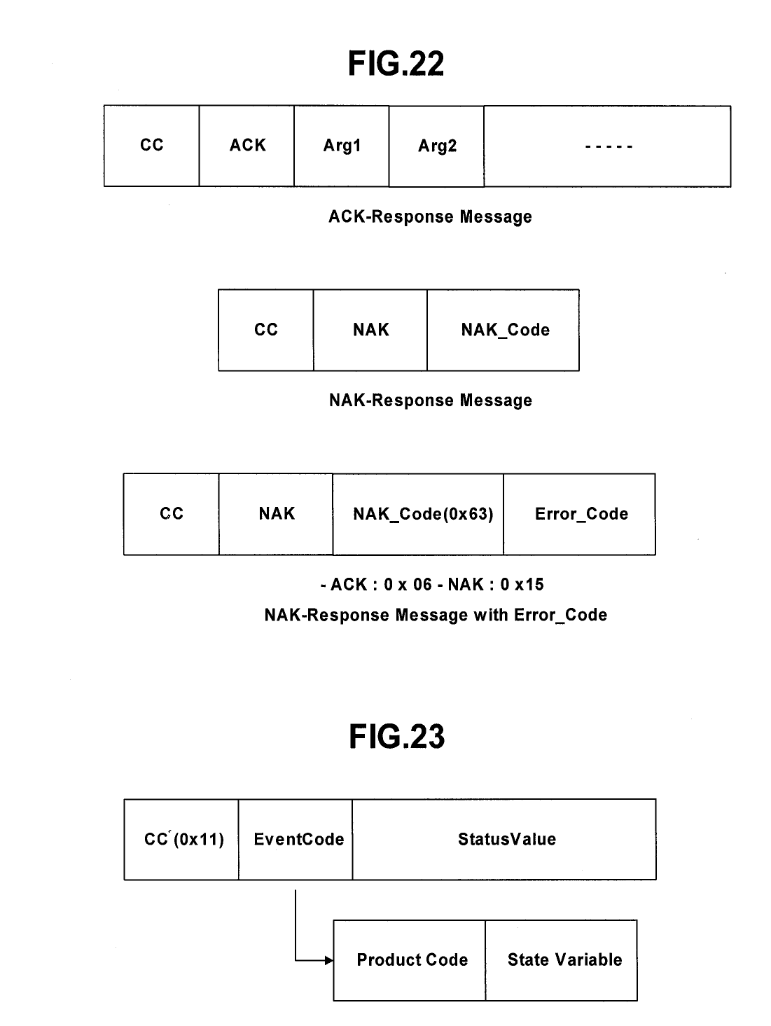

The response message is transferred from the application layer to the network layer at the slave or from the network layer to the application layer at the master so that the slave can transmit the result of the executed command to the master. Referring to FIG. 22, the response message is classified into an ACK-response message generated when the request message received from the master is normally executed, and an NAK-response message generated when the request message is not normally executed. The ACK-response message consists of the CC, ACK 0×06, and arguments indicative of the execution result. The ACK-response message is transmitted in case that the slave successfully carried out the request message received from the master.

The NAK-response message consists of the CC, NAK 0×15, and a 1-byte NAK_code. The NAK-response message is transmitted when the slave does not successfully execute the request message of the master. The NAK_code is a code value classifying cause why the slave does not successfully execute the request message because of wrong CC or argument during the communication between the master and the slave. The NAK_code is discriminated from error relating to the product operation.

The error relating to the product operation is represented as Error code. In case that the slave does not successfully execute the request message due to such error, the NAK_code value is fixed to 0×63 and the NAK_code is followed by Error_code value.

The event message is transferred from the application layer to the network layer at the source when the status of the device is changed. At the destination, the event message is transferred from the network layer to the application layer. Referring to FIG. 23, the event message is generated when the status of the device is changed, and consists of the CC 0×11, the 2-byte event code, and the 4-byte status value.

The upper 1 byte of the event code is the same as the product code, and the lower 1 byte is a state variable. The CC of the respective message is classified to 1 byte. The classification criterion is the capability to define a command common to all products, to provide basic network services, to apply unique functions of product, and to test the function of the product at the development phase.

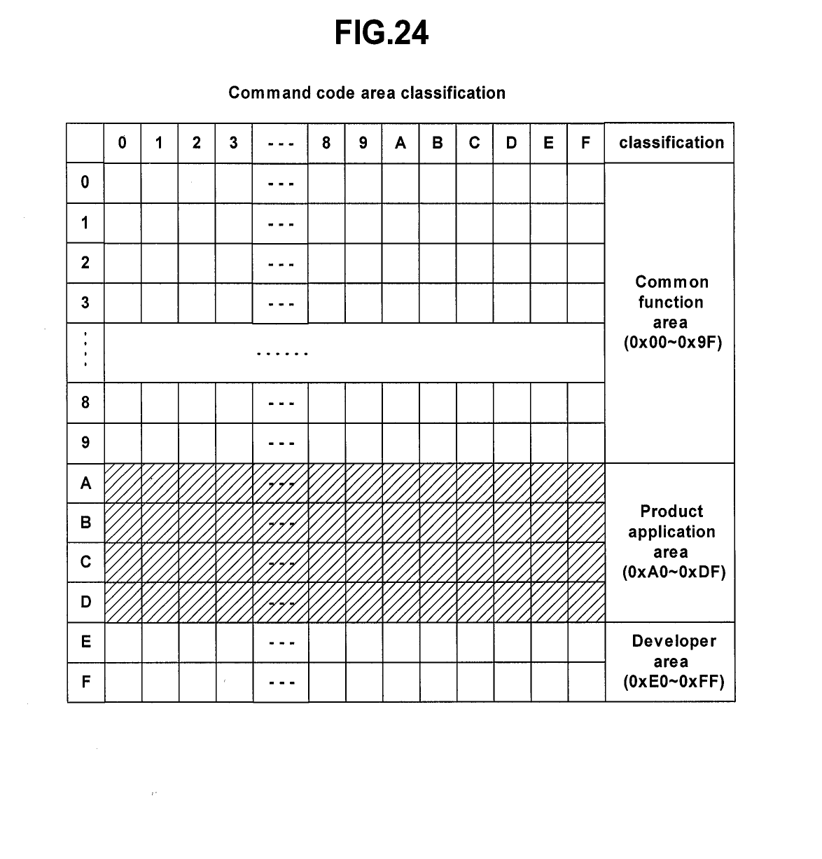

To this end, the CC, as shown in FIG. 24, can be divided into a common function area, a product application area, and a developer area. The common function area defines command codes to control and monitor the network establishment, the product information, and fundamental functions common to all products that participate in the LnCP network. The product application area defines command codes applied to execute unique functions of the products by types. The developer area defines command codes arbitrarily designated by the developer at the product development phase.

The messages handled in the application layer should be able to support extendability for adding functions in the LnCP network of the higher version, and compatibility among devices implemented using different LnCP message. For doing so, the LnCP message of the higher version can append extended arguments at the back of the lowest input argument of the request message or the lowest return argument of the response message for the sake of new functions.

The appended extended arguments are recognized only by a device where an LnCP message of the corresponding higher version is implemented, and ignored by a device where a lower version is implemented. A message for the control and the monitoring is a fixed-length message in the LnCP message. In case that an open-size data array such as download or upload is included, the message is a flexible-length message. The length of the flexible-length message can be adjustable in accordance with the buffer size of the device by means of the input argument of the request message.

In view of the foregoing, the packet structure and the packet transmission method of the network control protocol can provide the user with the remote control and the convenient monitoring. Furthermore, the packet structure at the application layer can be more efficiently defined and managed.

As describe above, while the present invention has been disclosed for the purpose of illustration with reference to the aforementioned preferred embodiment, other various names can be given to the living network and more various appliances can be connected to a living network according to the present invention, and it will be understood by those skilled in the art that the foregoing embodiment can be improved, modified, substituted or added in a variety of ways without departing from the technical spirit and scope of the invention as defined by the appended claims.

1. A packet transmission method of a network control protocol comprising:
generating a packet at an application layer of the network control protocol, the packet assigned a field to which one or more of a request message, a response message, and an event message is assigned, and an application layer protocol data unit header; and
interfacing layers in the network control protocol by transmitting the generated packet at the application layer.

2. The packet transmission method according to claim 1, wherein the application layer protocol data unit header is assigned one or more of an application layer protocol data unit length field, an application layer protocol data unit header length field, and an application layer option field.

3. The packet transmission method according to claim 2, wherein the application layer protocol data unit length field consists of 8 bits, and is 3 bytes at minimum and 77 bytes at maximum, and
a length of a used application layer protocol data unit is represented in the application layer protocol data unit length field by bytes.

4. The packet transmission method according to claim 2, wherein the application layer protocol data unit header length field consists of 8 bits and is extendable to 3 through 7 bytes to encrypt a message field or extend a message set.

5. The packet transmission method according to claim 2, wherein the application layer option field is a field for extending the message set, and selectively has a value of 0 according to an option.

6. The packet transmission method according to claim 1, wherein the request message is transferred from an application layer to a network layer at a master, or from a network layer to an application layer at a slave so that the slave executes a command.

7. The packet transmission method according to claim 6, wherein the request message consists of a command code and relevant arguments for executing the command code, and the request message is used to request device control and status check, and device information validation.

8. The packet transmission method according to claim 7, wherein the request message is classified into a downloading request message to transmit partitioned data to a device, and an uploading request message to acquire partitioned data from the device.

9. The packet transmission method according to claim 1, wherein the response message is transferred from the application layer to the network layer at the slave, or from the network layer to the application layer at the master so that the slave transmits a result of the executed command to the master.

10. The packet transmission method according to claim 9, wherein the response message is classified into an ACK-response message which is generated when a request message received from the master is successfully executed, and a NAK-response message which is generated when the request message is not successfully executed.

11. The packet transmission method according to claim 10, wherein the ACK-response message consists of a command code, ACK, and arguments indicative of the execution result, and
the NAK-response message consists of a command code, NAK, and a 1-byte NAK_code.

12. The packet transmission method according to claim 11, wherein the NAK_code is followed by an Error_code indicative of error relating to a product operation.

13. The packet transmission method according to claim 1, wherein the event message is transferred from an application layer to a network layer at a destination, and from a network layer to an application layer at a source when a device status is changed.

14. The packet transmission method according to claim 13, wherein the destination does not reply upon receiving the event message, and
an event message generated when a device is changed, consists of a command code, an event code, and a status value.

15. The packet structure transmission according to claim 14, wherein an upper 1 byte of the event code is the same as a product code, and a lower 1 byte indicates a state variable.

16. The packet transmission method according to claim 14, wherein the command code is classified into a common function area, a product application area, an a developer area,
the common function area defines network establishment, product information, and command codes which are common to all products participating in a network,
the product application area defines command codes applied to carry out unique functions of products by types, and
the developer area defines command codes arbitrarily by a developer at a product development phase.

17. The packet transmission method according to claim 1, wherein the network control protocol includes one or more of a physical layer, a data link layer, a network layer, and an application layer.

18. The packet transmission method according to claim 1, wherein the generated packet at the application layer is transmitted to other layer of the network control protocol.

19. A packet structure for interfacing layers in a network control protocol including an application layer, wherein the packet structure at the application layer is assigned a field including one or more of a request message, a response message, and an event message, and an application layer protocol data unit header.

20. The packet structure according to claim 19, wherein the application layer protocol data unit header is assigned is assigned one or more of an application layer protocol data unit length field, an application layer protocol data unit header length field, and an application layer option field.

21. A network device which includes a network control protocol including one or more of a physical layer, a data link layer, a network layer, and an application layer, wherein a packet structure of the application layer is assigned a field including one or more of a request message, a response message, and an event message, and an application layer protocol data unit header.
